(19) United States
(12) Patent Application Publication
(10) Pub. No.: US 2022/0101805 A1
(43) Pub. Date: Mar. 31, 2022

(54) DRIVING DEVICE AND DRIVING METHOD FOR BACKLIGHT MODULE

(71) Applicant: Coretronic Corporation, Hsin-Chu (TW)

(72) Inventors: Chun-Chi Hsu, Hsin-Chu (TW); Kun-Ming Yeh, Taichung City (TW)

(73) Assignee: Coretronic Corporation, Hsin-Chu (TW)

(21) Appl. No.: 17/396,780

(22) Filed: Aug. 9, 2021

(30) Foreign Application Priority Data
Sep. 29, 2020 (CN) 202011048843.0

(51) Int. Cl. G09G 3/34

(52) U.S. Cl. CPC G09G 3/3426; G09G 2330/028; G09G 3/3413

(57) ABSTRACT

A driving device and a driving method for a backlight module are provided. The driving device includes a current-to-voltage converter, a first LED driver, a second LED driver, and a switch. The current-to-voltage converter generates a control voltage corresponding to a control current of a first driving channel of the first LED driver. A control terminal of the switch is coupled to the current-to-voltage converter to receive the control voltage. A first terminal of the switch is configured to be coupled to a voltage source. A second terminal of the switch is configured to be coupled to a first terminal of a first light-emitting element of a backlight module. A second driving channel of the second LED driver is configured to be coupled to a second terminal of the first light-emitting element of the backlight module.

### CROSS-REFERENCE TO RELATED APPLICATION

This application claims the priority benefit of China application serial no. 202011048843.0, filed on Sep. 29, 2020. The entirety of the above-mentioned patent application is hereby incorporated by reference herein and made a part of this specification.

### BACKGROUND

### Technical Field

The disclosure relates to a backlight device, and particularly to a driving device and a driving method for a backlight module.

### Related Art

2D (2-Dimensional) local dimming backlight technology can be widely used in high-end liquid crystal displays (LCDs) having a high dynamic range (HDR) function. At present, with an increasing demand for high-definition screens, the number of dimming partitions needs to be increased, and the number of light-emitting diode (LED) drivers is thus increased. However, on the other hand, in order to reduce costs, the number of LED drivers (integrated circuits) should be as few as possible.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a driving device and a driving method configured to drive a backlight module, so as to realize a local dimming function.

In one embodiment of the disclosure, the driving device is configured to drive a backlight module. The driving device includes a first current-to-voltage converter, a first LED driver, a second LED driver, and a first switch. The first LED driver includes multiple driving channels. The first current-to-voltage converter is coupled to a first driving channel of the first LED driver. The first current-to-voltage converter is configured to generate a first control voltage corresponding to a control current of the first driving channel. A control terminal of the first switch is coupled to the first current-to-voltage converter to receive the first control voltage. A first terminal of the first switch is configured to be coupled to a voltage source. A second terminal of the first switch is configured to be coupled to a first terminal of a first light-emitting element of the backlight module. The second LED driver includes multiple driving channels. A second driving channel of the second LED driver is configured to be coupled to a second terminal of the first light-emitting element of the backlight module.

In one embodiment of the disclosure, the driving method is adapted for a driving device to drive a backlight module to provide backlight. The backlight module is divided into multiple backlight areas. The driving device includes a first LED driver, a first current-to-voltage converter, a first switch, and a second LED driver. The first current-to-voltage converter is configured to generate a first control voltage corresponding to a control current of a first driving channel of the first LED driver. A control terminal of the first switch receives the first control voltage. A first terminal of the first switch is configured to be coupled to a voltage source. A second terminal of the first switch is configured to be coupled to a first terminal of a first light-emitting element of the backlight module. A second driving channel of the second LED driver is configured to be coupled to a second terminal of the first light-emitting element of the backlight module. The driving method includes the following. During a period of generating the first control voltage, a first backlight area of the multiple backlight areas is lit, and driving data for driving a second backlight area of the multiple backlight areas is received by the second LED driver.

Based on the foregoing, in the driving device and the driving method according to the embodiments of the disclosure, a current-to-voltage converter and an LED driver are used to control a switch. The first current-to-voltage converter converts the control current of the first driving channel of the first LED driver into the first control voltage. The first switch determines whether to enable the first light-emitting element of the backlight module according to the first control voltage. With the first light-emitting element enabled, the second driving channel of the second LED driver is capable of controlling a current of the first light-emitting element. Therefore, the driving device facilitates the local dimming function.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a circuit block of a driving device and a backlight module according to the embodiment.

FIG. 2 is a schematic circuit diagram of the embodiment shown in FIG. 1.

FIG. 3 is a schematic timing diagram of signals shown in FIG. 2.

FIG. 4 is a schematic diagram of a circuit block of a driving device and a backlight module according to the embodiment of the disclosure.

FIG. 5 is a schematic circuit diagram of the embodiment shown in FIG. 4.

FIG. 6 is a schematic timing diagram of signals shown in FIG. 5.

FIG. 7 is a schematic flowchart of a driving method according to the embodiment of the disclosure.

FIG. 8 is a schematic circuit diagram of an LED driver shown in FIG. 4.

FIG. 9 is a schematic layout diagram of backlight areas of the backlight module shown in FIG. 5.

FIG. 10 is another schematic layout diagram of the backlight areas of the backlight module shown in FIG. 5.

FIG. 11 is still another schematic layout diagram of the backlight areas of the backlight module shown in FIG. 5.

FIG. 12 is another schematic circuit diagram of a switch circuit shown in FIG. 4.

FIG. 13 is another schematic timing diagram of backlight areas shown in FIG. 12.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

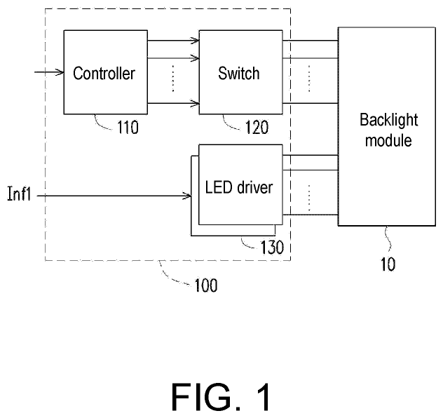

FIG. 1 is a schematic diagram of a circuit block of a driving device and a backlight module according to the embodiment. A driving device 100 is configured to drive a backlight module 10. The backlight module 10 includes a light-emitting element array (not shown), and the light-emitting element array includes multiple light-emitting elements. Depending on different design needs, the backlight module 10 may be a light-emitting diode (LED) backlight module or other backlight module, and the light-emitting elements may be LEDs or other light-emitting elements.

The driving device 100 shown in FIG. 1 includes a controller 110, a switch circuit 120, and an LED driver 130. The controller 110 may be a microcontroller unit (MCU), an application-specific integrated circuit (ASIC) or other control element/circuit. Depending on different design needs, the LED driver 130 may be implemented as a single integrated circuit or multiple integrated circuits. For example, in some embodiments, the LED driver 130 may include one or more LED driver integrated circuits having a daisy chain function. The LED driver integrated circuit having the daisy chain function may be a known LED driver or other LED driver.

Based on the operation of the controller 110 and the LED driver 130, the driving device 100 is configured to perform 2D local dimming function. Therefore, the driving device 100 and the backlight module 10 can be applied in high dynamic range (HDR) liquid crystal display (LCD) modules or other display panels. The driving device 100 of the disclosure makes it possible for each driving channel of the LED driver 130 (integrated circuit) to drive multiple light-emitting elements of the backlight module 10 in a time-sharing switching manner (for example, by scanning). Compared with a general non-time-sharing switching method, the number of driving channels of the LED driver 130 can be greatly decreased. Thus, there is no need to increase the number of driving channels of the LED driver 130 (that is, to decrease the number of LED driver integrated circuits) in response to an increase in the number of dimming partitions.

For example, the backlight module 10 may be divided into m backlight areas (that is, dimming partitions), and the same driving channel (for example, one driving channel) of the LED driver 130 drives a portion (one or more) of the light-emitting elements (such as LEDs) in each of the n backlight areas in a time-sharing switching manner. The time-sharing switching manner is implemented by the controller 110 and the switch circuit 120. The controller 110 may control ON time of each switch unit of the switch circuit 120, so as to scan (sequentially drive in a time-sharing switching manner) the m backlight areas. Furthermore, it is assumed that, in the case where time-sharing switching is not adopted, a lighting time and a driving current of one light-emitting element of the backlight module 10 are denoted by T and I, respectively. Then, in the case where time-sharing switching is adopted and the backlight module 10 is divided into n backlight areas, the lighting time of one light-emitting element becomes (1/m)*T, and the driving current of the light-emitting element becomes m*I (thereby achieving an equivalent module brightness).

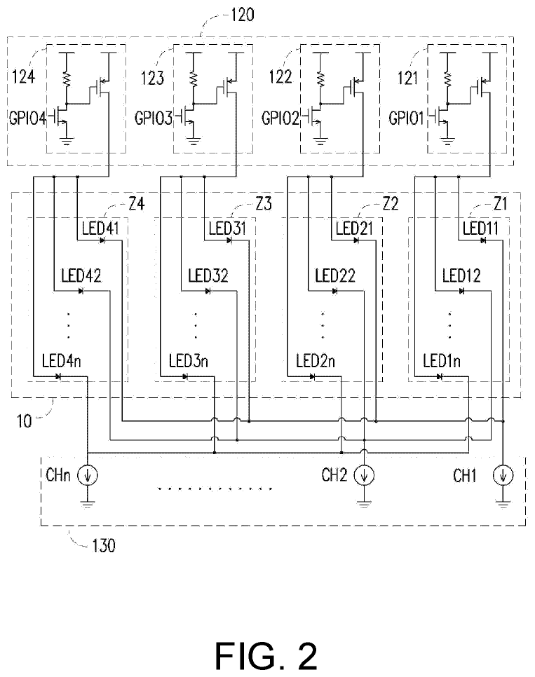

FIG. 2 is a schematic circuit diagram illustrating the switch circuit, the LED driver and the backlight module shown in FIG. 1 according to the embodiment. Referring to FIG. 1 and FIG. 2 together, in the embodiment shown in FIG. 2, the backlight module 10 may be divided into, for example, four backlight areas. For example, a first backlight area Z1 of the backlight module 10 includes light-emitting elements LED11, LED12, . . . , and LED1n; a second backlight area Z2 of the backlight module 10 includes light-emitting elements LED21, LED22, . . . , and LED2n; a third backlight area Z3 of the backlight module 10 includes light-emitting elements LED31, LED32, . . . , and LED3n; and a fourth backlight area Z4 of the backlight module 10 includes light-emitting elements LED41, LED42, . . . , and LED4n. Particularly, although the embodiment of FIG. 2 shows an example with four backlight areas, the disclosure is not limited thereto. The number of backlight areas may be increased or decreased according to needs.

In the embodiment shown in FIG. 2, the LED driver 130 includes n driving channels CH1, CH2, . . . , and CHn. A previous stage circuit (not shown, or the controller 110) may write a dimming information Inf1 into a control register (not shown) of the LED driver 130. The LED driver 130 may individually adjust a driving current of each of the driving channels CH1 to CHn, that is, adjust the brightness of each light-emitting element, according to the dimming information Inf1. Therefore, the LED driver 130 facilitates a local dimming function. In the embodiment of FIG. 2, there may be, for example, 4*n local dimming areas. In order to decrease the number of the driving channels CH1 to CHn, each of the driving channels CH1 to CHn is coupled to a portion of the light-emitting elements in each of the backlight areas Z1 to Z4 of the backlight module 10. For example, the driving channel CH1 is coupled to the light-emitting element LED11 in the backlight area Z1, the light-emitting element LED21 in the backlight area Z2, the light-emitting element LED31 in the backlight area Z3, and the light-emitting element LED41 in the backlight area Z4. The other driving channels CH2 to CHn can be understood by analogy from the description related to the driving channel CH1, and the description thereof will be omitted herein.

In order for a limited number of driving channels, i.e., the driving channels CH1 to CHn, to drive a large number of light-emitting elements by scanning (time-sharing switching), the switch circuit 120 of the driving device 100 includes multiple switch units 121, 122, 123, and 124, and the number of the switch units 121 to 124 corresponds to the number of the backlight areas Z1 to Z4 of the backlight module 10. The controller 110 of the driving device 100 may output control signals GPIO1, GPIO2, GPIO3, and GPIO4 to control the switch units 121 to 124.

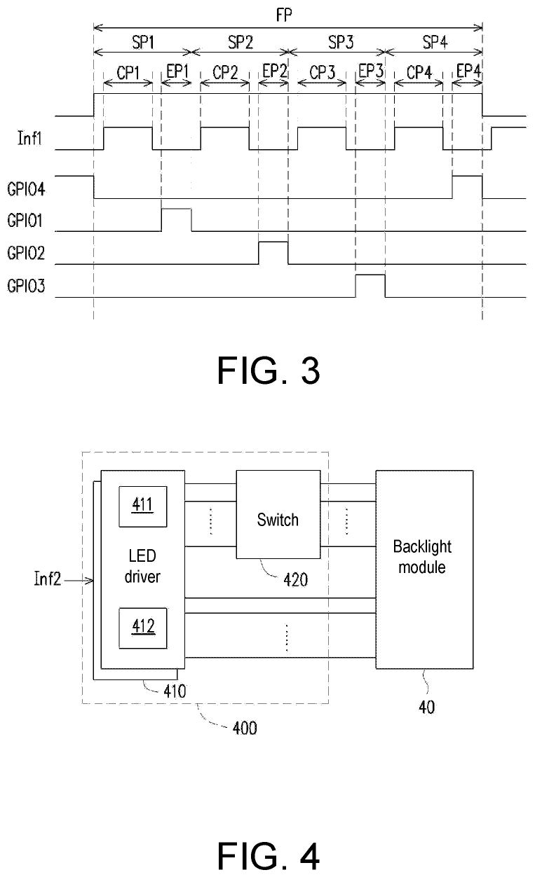

FIG. 3 is a schematic timing diagram illustrating signals shown in FIG. 2 according to the embodiment. In FIG. 3, the horizontal axis indicates time, and the vertical axis indicates signal level. Referring to FIG. 2 and FIG. 3 together, in the embodiment shown in FIG. 3, a frame period FP includes sub-periods SP1, SP2, SP3, and SP4. The switch units 121 to 124 may respectively turn on the backlight areas Z1 to Z4 of the backlight module 10 during the sub-periods SP1 to SP4. However, in the embodiment shown in FIG. 2, since a clock signal (not shown) of the controller 110 is different from a clock signal (not shown) of the LED driver 130, it is difficult to control an actuation timing of each of the driving channels CH1 to CHn. Thus, to prevent mutual interference was caused by an actuation timing of the controller 110 and an actuation timing of the LED driver 130, the sub-periods SP1 to SP4 of this embodiment may further be divided into change periods CP1, CP2, CP3 and CP4 as well as light emission periods EP1, EP2, EP3 and EP4, as shown in FIG. 3. In this way, there is no overlapping between the time (change periods CP1, CP2, CP3, and CP4) for changing driving parameters of the LED driver 130 and enable time (light emission periods EP1, EP2, EP3, and EP4) of the backlight areas Z1 to Z4 of the backlight module 10, such that local dimming is accurately controlled.

Particularly, the waveform of the dimming information Inf1 shown in FIG. 3 is only for illustrative purposes. The dimming information Inf1 contains multiple pulses and not all of them are shown. In FIG. 3, a high level of the dimming information Inf1 means “a driving parameter of the LED driver 130 can be changed”, and a low level thereof means “no driving parameter of the LED driver 130 is changed.” The driving parameter of the LED driver 130 is, for example, a pulse width modulation (PWM) parameter. During the change period CP1 of the sub-period SP1, the previous stage circuit (not shown, or the controller 110) may write the dimming information Inf1 to the control register (not shown) of the LED driver 130 so as to change a driving parameter corresponding to the backlight area Z1. After the change period CP1 ends, the controller 110 may control the switch units 121 to 124 during the light emission period EP1 so that the switch units 122, 123, and 124 are turned off and the switch unit 121 is turned on, thereby disabling the backlight areas Z2, Z3, and Z4 and enabling the backlight area Z1. Operation of the other sub-periods SP2 to SP4 can be understood by analogy from the description related to the sub-period SP1, and the description thereof will be omitted herein. In this way, the actuation timing of the controller 110 and the actuation timing of the LED driver 130 do not interfere with each other.

Furthermore, the sub-periods SP1 to SP4 of the driving device 100 in FIG. 1 to FIG. 3 respectively include the change period CP1 and the light emission period EP1, the change period CP2 and the light emission period EP2, the change period CP3 and the light emission period EP3, and the change period CP4 and the light emission period EP4. Since the time length of the light emission periods EP1, EP2, EP3 and EP4 are reduced, it is necessary for the driving channels CH1 to CHn of the LED driver 130 to provide more driving current to the light-emitting elements in the backlight areas Z1 to Z4 of the backlight module 10.

In order to reduce the need for the driving current (reduce the current peak value), the function of the driving device 100 of FIG. 1 can be performed instead by an LED driver. FIG. 4 is a schematic diagram of a circuit block of a driving device and a backlight module according to the embodiment of the disclosure. A difference between a driving device 400 of FIG. 4 and the driving device 100 of FIG. 1 lies in the configuration of the LED driver. The driving device 400 shown in FIG. 4 is configured to drive a backlight module 40. The backlight module 40 is similar to the backlight module 10 shown in FIG. 1 and can be understood by analogy from the description related to the backlight module 10 shown in FIG. 1, and therefore, the description thereof will be omitted herein. The driving device 400 shown in FIG. 4 includes a light-emitting diode (LED) driver 410 and a switch circuit 420. Specifically, the LED driver 410 may include, for example, the functions of the driving device 110 and the LED driver 130 of FIG. 1. Depending on design needs, the LED driver 410 may be implemented as a single integrated circuit or multiple integrated circuits. For example, in some embodiments, the LED driver 410 may include one or more LED driver integrated circuits having the daisy chain function. The LED driver integrated circuit having the daisy chain function may be a known LED driver or other LED driver.

In the following embodiment, the LED driver 410 may include a first LED driver 411 and a second LED driver 412. The first LED driver 411 includes multiple driving channels for providing a control current for controlling the switch circuit 420. Based on control of the first LED driver 411, the switch circuit 420 may control multiple backlight areas of the backlight module 40 respectively. The second LED driver 412 includes multiple driving channels for providing a current for driving a light-emitting element of the backlight module 40. Depending on design needs, in some embodiments, the first LED driver 411 and the second LED driver 412 may have the same circuit design. Specifically, the first LED driver 411 and the second LED driver 412 may be drivers of the same model.

Based on control of the LED driver 410, the driving device 400 is also configured to perform 2D local dimming. Therefore, the driving device 400 and the backlight module 40 can be applied in HDR LCD modules or other display panels. Each driving channel of the second LED driver 412 drives multiple light-emitting elements of the backlight module 40 in a time-sharing switching manner (for example, by scanning), so as to decrease the number of driving channels of the second LED driver 412.

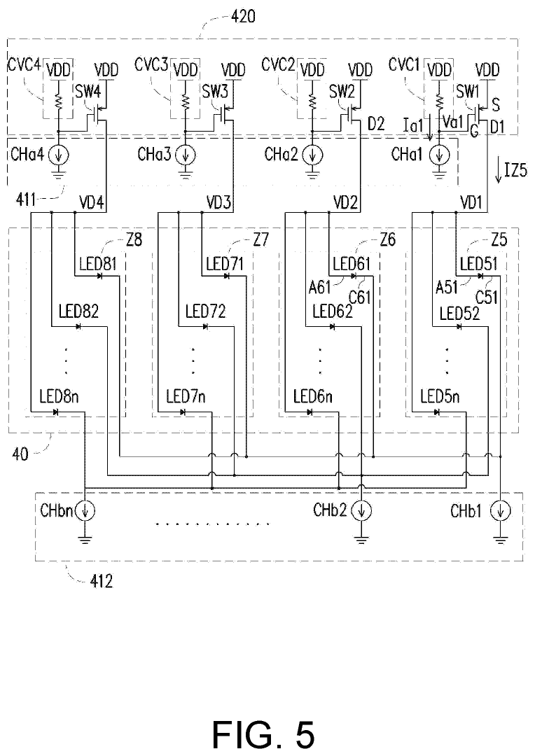

FIG. 5 is a schematic circuit diagram of the embodiment shown in FIG. 4. Referring to FIG. 4 and FIG. 5 together, in the embodiment shown in FIG. 5, the backlight module 40 may be divided into, for example, four backlight areas Z5 to Z8. For example, the first backlight area Z5 of the backlight module 40 includes a first light-emitting element LED51, a second light-emitting element LED52, . . . , and a light-emitting element LED5n; the second backlight area Z6 of the backlight module 40 includes a third light-emitting element LED61, a light-emitting element LED62, . . . , and a light-emitting element LED6n; the third backlight area Z7 of the backlight module 40 includes light-emitting elements LED71, LED72, . . . , and LED7n; and the backlight area Z8 of the backlight module 40 includes light-emitting elements LED81, LED82, . . . , and LED8n. Specifically, n denotes the number of light-emitting elements or the number of groups of light-emitting elements in each backlight area. That is, the first light-emitting element LED51 may include one or more light-emitting elements. Depending on different design needs, in some embodiments, the light emitted by the light-emitting elements of the backlight module 40 may be light of the same color (for example, white light). In other embodiments, the light emitted by the light-emitting elements of the backlight module 40 may be light of different colors (for example, two or more of white light, red light, green light, and blue light).

Furthermore, the switch circuit 420 includes multiple current-to-voltage converters (for example, current-to-voltage converters CVC1, CVC2, CVC3, and CVC4) and multiple switches (for example, switches SW1, SW2, SW3, and SW4). The number of the current-to-voltage converters CVC1 to CVC4 corresponds to the number of the backlight areas Z5 to Z8 of the backlight module 40, and the number of the switches SW1 to SW4 also corresponds to the number of the backlight areas Z5 to Z8.

In the embodiment shown in FIG. 5, the first LED driver 411 includes a first driving channel CHa1, a fourth driving channel CHa2, and driving channels CHa3 and CHa4 (the number of the driving channels of the first LED driver 411 corresponds to the number of the backlight areas of the backlight module 40). A previous stage circuit (not shown) may write dimming information Inf2 to a control register (not shown) of the first LED driver 411. The first LED driver 411 may individually adjust a control current of each of the driving channels CHa1 to CHa4 according to the dimming information Inf2. Therefore, the first LED driver 411 facilitates the scanning (time-sharing switching) function.

In detail, one end of the first current-to-voltage converter CVC1 is coupled to the first driving channel CHa1 of the first LED driver 411, and the other end of the first current-to-voltage converter CVC1 is coupled to a voltage source VDD. The first current-to-voltage converter CVC1 may generate a first control voltage Val corresponding to a control current Ia1 of the first driving channel CHa1 and provide the first control voltage Val to a control terminal G of the first switch SW1. The control terminal G of the first switch SW1 is coupled to the first current-to-voltage converter CVC1 (that is, to the first driving channel CHa1 of the first LED driver 411) to receive the first control voltage Val. A first terminal S of the first switch SW1 is configured to be coupled to the voltage source VDD. A level of the voltage source VDD may be determined according to design needs. A second terminal D1 of the first switch SW1 is configured to be coupled to respective first terminals of the first light-emitting element LED51, the second light-emitting element LED52, . . . , and the light-emitting element LED5n in the first backlight area Z5 of the backlight module 40. For example, the second terminal D1 of the first switch SW1 is coupled to a first terminal A51 of the first light-emitting element LED51 in the first backlight area Z5, and a second terminal D2 of the second switch SW2 is coupled to a first terminal A61 of the third light-emitting element LED61 in the second backlight area Z6. Other driving channels such as the fourth driving channel CHa2 and the driving channels CHa3 and CHa4, other current-to-voltage converters such as the second current-to-voltage converter CVC2 and the current-to-voltage converters CVC3 and CVC4, and other switches such as the switches SW2 to SW4 can be understood by analogy from the description related to the first driving channel CHa1, the first current-to-voltage converter CVC1 and the first switch SW1, and the description thereof will be omitted herein. For example, the second current-to-voltage converter CVC2 is coupled to the fourth driving channel CHa2 of the first LED driver 411, and is configured to generate a second control voltage corresponding to a current of the fourth driving channel CHa2. The second switch SW2 has a control terminal coupled to the second current-to-voltage converter CVC2 to receive the second control voltage, and a first terminal of the second switch SW2 is configured to be coupled to the voltage source VDD.

In the embodiment shown in FIG. 5, the second LED driver 412 includes n driving channels CHb1, CHb2, . . . , and CHbn (the number of the driving channels of the second LED driver 412 corresponds to the number of light-emitting elements or the number of groups of light-emitting elements in each backlight area). Particularly, the n driving channels CHb1, CHb2, . . . , and CHbn may not belong to the same LED driver, and may respectively belong to different LED drivers in other embodiments. In order to decrease the number of the driving channels CHb1 to CHbn, each of the driving channels CHb1 to CHbn is coupled to a portion (for example, one or more) of the light-emitting elements in each of the backlight areas Z5 to Z8 of the backlight module 40. For example, the second driving channel CHb1 is coupled to a second terminal C51 of the first light-emitting element LED51 in the first backlight area Z5, a second terminal C61 of the third light-emitting element LED61 in the second backlight area Z6, a second terminal of the light-emitting element LED71 in the third backlight area Z7, and a second terminal of the light-emitting element LED81 in the backlight area Z8. The third driving channel CHb2 is coupled to a second terminal of the second light-emitting element LED52 in the first backlight area Z5, a second terminal of the light-emitting element LED62 in the second backlight area Z6, a second terminal of the light-emitting element LED72 in the third backlight area Z7, and a second terminal of the light-emitting element LED82 in the backlight area Z8. The other driving channels CHb3 to CHbn can be understood by analogy from the description related to the second driving channel CHb1 and the third driving channel CHb2, and the description thereof will be omitted herein. A previous stage circuit (not shown) may write the dimming information Inf2 to a control register (not shown) of the second LED driver 412. The second LED driver 412 may individually adjust a driving current of each of the driving channels CHb1 to CHbn, that is, adjust the brightness of each light-emitting element, according to the dimming information Inf2. Therefore, the second LED driver 412 facilitates the local dimming function. In the embodiment of FIG. 5, there may be, for example, 4*n local dimming areas. The second LED driver 412 shown in FIG. 5 can be understood by analogy from the description related to the LED driver 130 shown in FIG. 2. Particularly, the first light-emitting element LED51 is of the same color as the second light-emitting element LED52. However, the disclosure is not limited thereto. In other embodiments, the first light-emitting element LED51 may be of a different color from the second light-emitting element LED52.

Depending on design needs and/or application needs, in some embodiments, the first driving channel CHa1 may control/determine the magnitude of a total current IZ5 for the first backlight area Z5. When the first driving channel CHa1 performs driving, the first control voltage Val corresponding to the control current Ia1 determines a resistance of the first switch SW1, thereby determining the magnitude of the total current IZ5 for the first backlight area Z5. The other switches SW2 to SW4 can be understood by analogy. Therefore, in such an embodiment, the driving channels CHa1 to CHa4 may control/determine the total current of the backlight areas Z5 to Z8, respectively.

In other embodiments, the magnitude of the total current for the backlight areas Z5 to Z8 may be controlled/determined by the driving channels CHb1 to CHbn. In such an embodiment, the driving channels CHa1 to CHa4 and the current-to-voltage converters CVC1 to CVC4 may set the resistances of the switches SW1 to SW4 as small as possible through the control voltage.

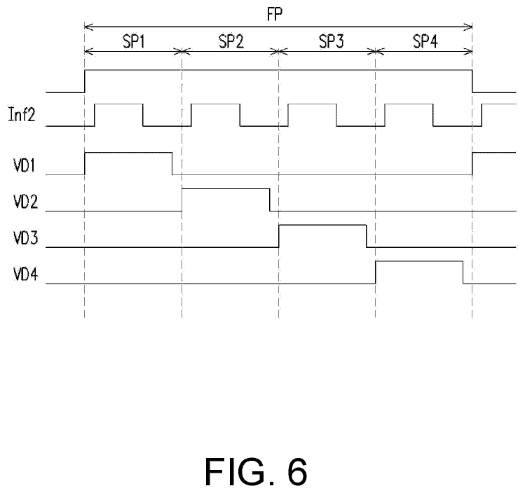

FIG. 6 is a schematic timing diagram illustrating signals shown in FIG. 5. In FIG. 6, the horizontal axis indicates time, and the vertical axis indicates signal level. The waveform of the dimming information Inf2 shown in FIG. 6 is only for illustrative purposes, in which a high level means “a driving parameter of the second LED driver 412 can be changed”, and a low level means “no driving parameter of the second LED driver 412 is changed.” The driving parameter of the second LED driver 412 is, for example, a PWM parameter. Voltages VD1, VD2, VD3, and VD4 shown in FIG. 6 represent voltages at the control terminals of the switches SW1 to SW4 shown in FIG. 5. In the embodiment shown in FIG. 6, the frame period FP includes the sub-periods SP1, SP2, SP3, and SP4. Based on control of the first LED driver 411, a signal level (voltage level) of a control terminal of the switch circuit 420 may be increased to a high level during the sub-periods SP1 to SP4 respectively, as shown by the voltages VD1 to VD4, so as to scan the backlight areas Z5 to Z8 of the backlight module 40. Particularly, in this embodiment, the high level of the voltages VD1 to VD4 cause the switches SW1 to SW4 to reach a maximum ON state, and the brightness of a light-emitting element is adjusted according to the magnitude of the driving current of each of the driving channels CHb1 to CHbn. However, the disclosure is not limited thereto. In other embodiments, the high level of the voltages VD1 to VD4 may cause the switches SW1 to SW4 to reach different ON states. That is, the driving current of a light-emitting element can be controlled or limited by the switches SW1 to SW4.

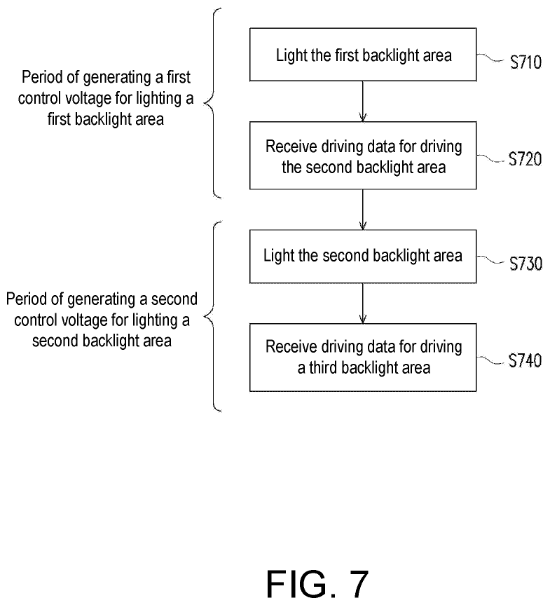

FIG. 7 is a schematic flowchart of a driving method according to the embodiment of the disclosure. Please refer to FIG. 5, FIG. 6 and FIG. 7. During a period which the first current-to-voltage converter CVC1 generates the first control voltage Val for lighting the first backlight area Z5 (the voltage VD1 is at a high level as shown in FIG. 6), that is, during the sub-period SP1, the control terminal of the first switch SW1 receives a high-level voltage. Accordingly, a driving current can be output to light (enable) the first backlight area Z5 (step S710), and the second LED driver 412 may receive driving data (dimming information Inf2) for driving the second backlight area Z6 (step S720). That is, during the sub-period SP1, the previous stage circuit (not shown) may write the dimming information Inf2 to the control register (not shown) of the second LED driver 412, so as to change a driving parameter such as PWM parameter corresponding to the second backlight area Z6. In this way, during the change of the driving parameter corresponding to the second backlight area Z6, the first LED driver 411 may turn on the first switch SW1, so that a power supply (for example, the voltage source VDD) (not shown) provides the driving current to the first backlight area Z5.

During a period which the second current-to-voltage converter CVC2 generates the second control voltage for lighting the second backlight area Z6, when the voltage VD2 is at a high level as shown in FIG. 6, that is, during the sub-period SP2, the control terminal of the second switch SW2 receives a high-level voltage. Accordingly, a driving current can be output to light (enable) the second backlight area Z6 (step S730), and the second LED driver 412 may receive the driving data (dimming information Inf2) for driving the third backlight area Z7 (step S740). That is, during the sub-period SP2, a driving parameter of the second LED driver 412 corresponding to the third backlight area Z7 may be changed, and the first LED driver 411 may turn on the second switch SW2 at the same time to provide the driving current to the second backlight area Z6. The sub-periods SP3 and SP4 can be understood by analogy from the description related to the sub-periods SP1 and SP2, and the description thereof will be omitted herein. Specifically, the sub-periods SP1 to SP4 are continuous periods and do not overlap each other, that is, the voltages VD1 to VD4 will not all be at a high level at the same time.

Referring again to FIG. 5, in the embodiment shown in FIG. 5, the first LED driver 411 that controls the switches SW1 to SW4 and the second LED driver 412 that drives the light-emitting elements of the backlight module 40 may have the same clock signal. Accordingly, the timing (time period) of changing the PWM parameter can be easily adjusted, and the actuation timing of the first LED driver 411 can be easily synchronized with the actuation timing of the second LED driver 412. Hence, the time (time period) for changing the PWM parameter of the second LED driver 412 may overlap the enable (lighting) time of the backlight areas Z5 to Z8 of the backlight module 40, as shown in FIG. 6. Therefore, the length of the enable (lighting) time of the backlight areas Z5 to Z8 may be as close as possible to the length of a sub-period (for example, any one of the sub-periods SP1 to SP4). In addition, a controller (for example, the controller 110 shown in FIG. 1) may be omitted from the driving device 400 shown in FIG. 4.

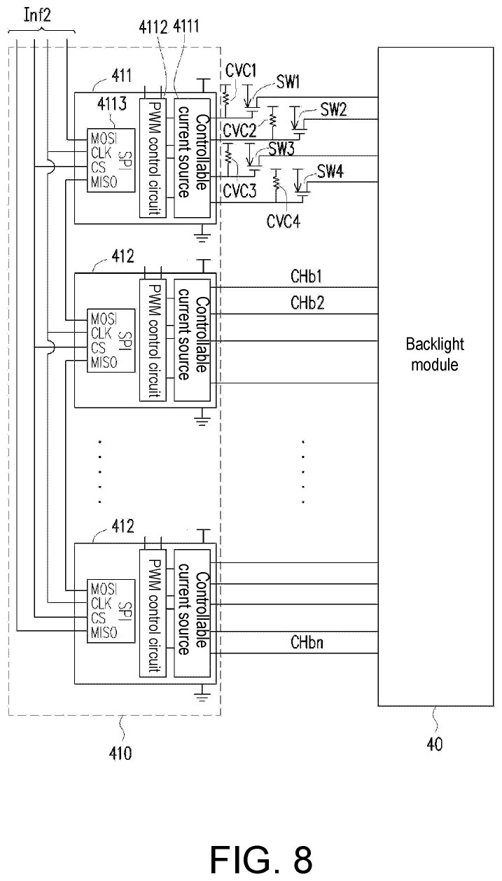

FIG. 8 is a schematic circuit diagram of an LED driver shown in FIG. 4. In the embodiment shown in FIG. 8, the LED driver 410 may include multiple LED driver integrated circuits having the daisy chain function. One of the LED driver integrated circuits is used as the first LED driver 411, and the other LED driver integrated circuits are used as the second LED driver 412. The first LED driver 411 and the second LED driver 412 shown in FIG. 8 can be understood by analogy from the description related to the first LED driver 411 and the second LED driver 412 shown in FIG. 5.

In the embodiment shown in FIG. 8, the first LED driver 411, that is, the driving channels CHa1, CHa2, CHa3 and CHa4, include a controllable current source 4111 and a pulse width modulation (PWM) control circuit 4112. The previous stage circuit (not shown) may write the dimming information Inf2 to the control register (not shown) of the first LED driver 411 via an interface circuit 4113 of the first LED driver 411. The PWM control circuit 4112 may control a control current of the controllable current source 4111 (which includes the driving channels CHa1 to CHa4 shown in FIG. 5) according to the driving data (dimming information Inf2) of the control register. Next, the controllable current source 4111 of the first LED driver 411 is coupled to the current-to-voltage converters CVC1 to CVC4 to provide the control current. The current-to-voltage converters CVC1 to CVC4 may convert the control current of the first LED driver 411 into a control voltage, and provide the control voltage to the control terminals of the switches SW1 to SW4. Therefore, the switches SW1 to SW4 may output the driving current during the sub-periods SP1 to SP4 to scan the backlight areas Z5 to Z8 of the backlight module 40. Particularly, the circuit of the second LED driver 412 and an output method of the control current can be understood by analogy from the description related to the first LED driver 411, and the description thereof will be omitted herein.

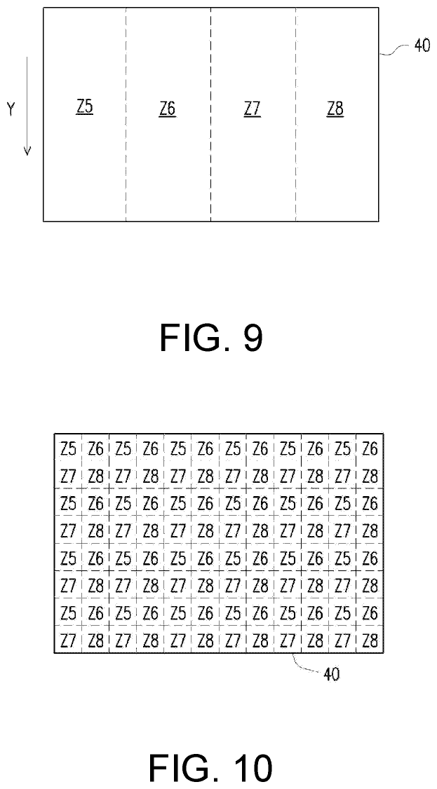

FIG. 9 is a schematic layout diagram of backlight areas of the backlight module shown in FIG. 5. In the embodiment shown in FIG. 9, the backlight module 40 provides backlight to a display panel (not shown), and each of the backlight areas Z5 to Z8 of the backlight module 40 is a single continuous area (non-discrete area). A long side direction of each of the backlight areas Z5 to Z8 is parallel to a short side direction (scanning direction Y) of the display panel.

FIG. 10 is another schematic layout diagram of the backlight areas of the backlight module shown in FIG. 5. In the embodiment shown in FIG. 10, the backlight module 40 provides backlight to the display panel (not shown), and each of the backlight areas Z5 to Z8 of the backlight module 40 includes multiple discrete areas, as shown in FIG. 10. A display area of the display panel may be divided into multiple sub-areas, and each of the sub-areas corresponds to at least one discrete area of each of the backlight areas Z5 to Z8 of the backlight module 40. Specifically, the backlight areas Z5 to Z8 may correspond to multiple pixels of the display panel. However, the disclosure is not limited thereto. In other embodiments, the first backlight area Z5 may correspond to a red light-emitting element, the second backlight area Z6 may correspond to a green light-emitting element, the third backlight area Z7 may correspond to a blue light-emitting element, and the backlight area Z8 may correspond to a white light-emitting element.

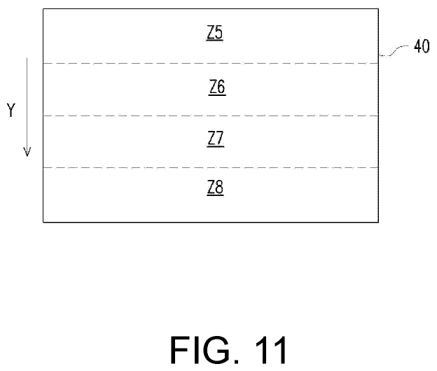

FIG. 11 is still another schematic layout diagram of the backlight areas of the backlight module shown in FIG. 5. In the embodiment shown in FIG. 11, the backlight module 40 provides backlight to the display panel (not shown), and each of the backlight areas Z5 to Z8 of the backlight module 40 is a single continuous area (non-discrete area), as shown in FIG. 11. The backlight areas Z5 to Z8 are arranged along an arrangement direction parallel to a screen refresh direction (scanning direction Y) of the display panel.

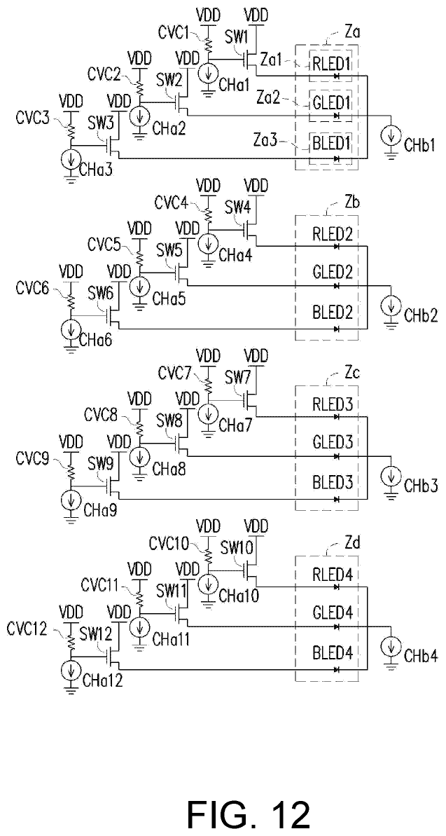

FIG. 12 is another schematic circuit diagram of a switch circuit and the backlight module shown in FIG. 4. Referring to FIG. 4 and FIG. 12 together, in the embodiment shown in FIG. 12, the backlight module 40 may be divided into, for example, four backlight areas Za to Zd. The first backlight area Za of the backlight module 40 includes a red light-emitting element RLED1 (also a sub-backlight area Za1), a green light-emitting element GLED1 (also a sub-backlight area Za2) and a blue light-emitting element BLED1 (also a sub-backlight area Za3). The second backlight area Zb of the backlight module 40 includes a red light-emitting element RLED2, a green light-emitting element GLED2, and a blue light-emitting element BLED2. The backlight area Zc of the backlight module 40 includes a red light-emitting element RLED3, a green light-emitting element GLED3 and a blue light-emitting element BLED3. The backlight area Zd of the backlight module 40 includes a red light-emitting element RLED4, a green light-emitting element GLED4, and a blue light-emitting element BLED4.

In the embodiment shown in FIG. 12, the switch circuit 420 includes multiple current-to-voltage converters (for example, current-to-voltage converters CVC1, CVC2, CVC3, CVC4, CVCS, CVC6, CVC7, CVC8, CVC9, CVC10, CVC11, and CVC12) and multiple switches (for example, switches SW1, SW2, SW3, SW4, SW5, SW6, SW7, SW8, SW9, SW10, SW11, and SW12). A first terminal of the red light-emitting element RLED1 in the sub-backlight area Za1 of the first backlight area Za is coupled to the first switch SW1. A first terminal of the green light-emitting element GLED1 in the sub-backlight area Za2 of the first backlight area Za is coupled to the second switch SW2. A first terminal of the blue light-emitting element BLED1 in the sub-backlight area Za3 of the first backlight area Za is coupled to the switch SW3. The other backlight areas Zb to Zd can be understood by analogy from the description related to the first backlight area Za, and the description thereof will be omitted herein. Particularly, the red light-emitting element RLED1 may include one or more red light-emitting elements, and the same applies to the other light-emitting elements. That is, the sub-backlight area Za1 may include a single or a group of light-emitting elements. However, the disclosure is not limited thereto. In other embodiments, the sub-backlight area Za1 may include multiple groups of light-emitting elements.

Furthermore, the first LED driver 411 includes the driving channels CHa1, CHa2, CHa3, CHa4, CHa5, CHa6, CHa7, CHa8, CHa9, CHa10, CHa11, and CHa12. The first LED driver 411 may individually control or adjust a control current of each of the driving channels CHa1 to CHa12 according to the dimming information Inf2, so as to realize the scanning (time-sharing switching) function (the output periods of the driving channels CHa1, CHa2 and CHa3 do not overlap each other). Operation of the first LED driver 411 and the switch circuit 420 in the embodiment shown in FIG. 12 can be understood by analogy from the description related to the first LED driver 411 and the switch circuit 420 shown in FIG. 5, and the description thereof will be omitted herein.

In the embodiment shown in FIG. 12, the second LED driver 412 includes multiple driving channels, for example, the driving channels CHb1, CHb2, CHb3, and CHb4 shown in FIG. 12, as well as other driving channels not shown in FIG. 12. The second driving channel CHb1 is coupled to a second terminal of the red light-emitting element RLED1, a second terminal of the green light-emitting element GLED1, and a second terminal of the blue light-emitting element BLED1. The second LED driver 412 may individually adjust the driving current of each driving channel of the second LED driver 412 according to the dimming information Inf2. Therefore, the second LED driver 412 facilitates the local dimming function. The second LED driver 412 in the embodiment shown in FIG. 12 can be understood by analogy from the description related to the second LED driver 412 shown in FIG. 5, and the description thereof will be omitted herein.

In other embodiments, the backlight module 40 may be used as a color field sequential backlight unit. Based on control of the first LED driver 411, the switches SW1, SW4, SW7, and SW10 may drive the red light-emitting element of the backlight module 40 during a first period to provide red light (first color light) to a display panel (not shown). During a second period after the first period has ended, the switches SW2, SW5, SW8, and SW11 may drive the green light-emitting element of the backlight module 40 to provide green light (second color light) to the display panel. During a third period after the second period has ended, the switches SW3, SW6, SW9, and SW12 may drive the blue light-emitting element of the backlight module 40 to provide blue light (third color light) to the display panel. In this way, red backlight, green backlight and blue backlight can be provided in sequence to achieve a color field sequential backlight function.

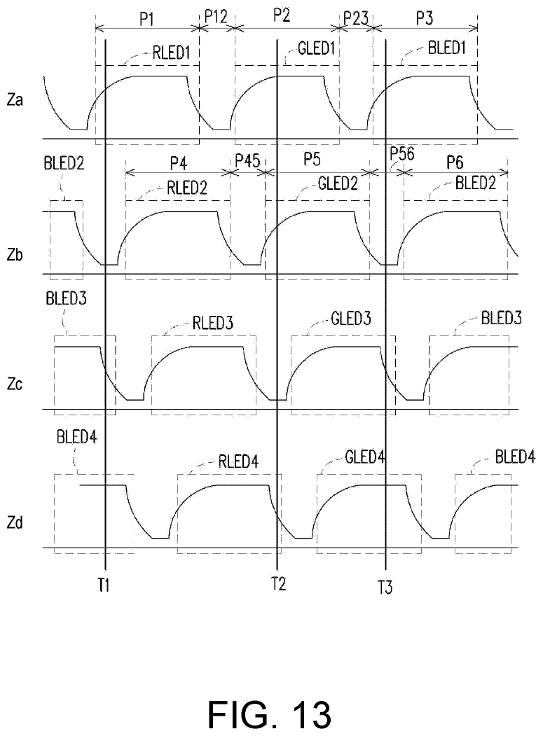

FIG. 13 is a schematic timing diagram of the backlight areas Za to Zd shown in FIG. 12. Please refer to FIG. 4, FIG. 12 and FIG. 13 together. In FIG. 13, the horizontal axis indicates time, and the vertical axis indicates the brightness of a light-emitting element. During a first period P1, the driving device 400 may drive the first backlight area Za to provide the first color light (for example, red light) to the display panel (not shown). During a skip period P12 between the first period P1 and a second period P2, the driving device 400 may control the first backlight area Za not to emit light. During the second period P2 after the first period P1 has ended, the driving device 400 may drive the first backlight area Za to provide the second color light (for example, green light) to the display panel. During a skip period P23 between the second period P2 and a third period P3, the driving device 400 may control the first backlight area Za not to emit light. During the third period P3 after the second period P2 has ended, the driving device 400 may drive the first backlight area Za to provide the third color light (for example, blue light) to the display panel.

During a fourth period P4, the driving device 400 may drive the second backlight area Zb to provide the first color light (for example, red light) to the display panel (not shown). A start time of the fourth period P4 is later than a start time of the first period P1, and the fourth period P4 partially overlaps the first period P1. During a skip period P45 between the fourth period P4 and a fifth period P5, the driving device 400 may control the second backlight area Zb not to emit light. During the fifth period P5 after the fourth period P4 has ended, the driving device 400 may drive the second backlight area Zb to provide the second color light (for example, green light) to the display panel. A start time of the fifth period P5 is later than a start time of the second period P2, and the fifth period P5 partially overlaps the second period P2. During a skip period P56 between the fifth period P5 and a sixth period P6, the driving device 400 may control the second backlight area Zb not to emit light. During the sixth period P6 after the fifth period P5 has ended, the driving device 400 may drive the second backlight area Zb to provide the third color light (for example, blue light) to the display panel. A start time of the sixth period P6 is later than a start time of the third period P3, and the sixth period P6 partially overlaps the third period P3.

Please refer to FIG. 12 and FIG. 13. At time T1, all the red light-emitting elements (such as the red light-emitting element RLED1) in the first backlight area Za are driven to emit red light (for example, the sub-backlight area Za1 is lit), all the light-emitting elements in the second backlight area Zb are disabled and do not emit light, all the blue light-emitting elements (such as the blue light-emitting element BLED3) in the backlight area Zc are driven to emit blue light, and all the blue light-emitting elements (such as the blue light-emitting element BLED4) in the backlight area Zd are driven to emit blue light. At time T2, all the green light-emitting elements (such as the green light-emitting element GLED1) in the first backlight area Za are driven to emit green light, all the green light-emitting elements (such as the green light-emitting element GLED2) in the second backlight area Zb are driven to emit green light, all the light-emitting elements in the backlight area Zc are disabled and do not emit light, and all the red light-emitting elements (such as the red light-emitting element RLED4) in the backlight area Zd are driven to emit red light. At time T3, all the blue light-emitting elements (such as the blue light-emitting element BLED1) in the first backlight area Za are driven to emit blue light, all the light-emitting elements in the second backlight area Zb are disabled and do not emit light, all the green light-emitting elements (such as the green light-emitting element GLED3) in the backlight area Zc are driven to emit green light, and all the green light-emitting elements (such as the green light-emitting element GLED4) in the backlight area Zd are driven to emit green light.

Depending on different design needs, the LED driver 410, the first LED driver 411, and/or the second LED driver 412 may be implemented by hardware, firmware, software (i.e., program), or a combination of two or more thereof.

In terms of hardware, the LED driver 410, the first LED driver 411, and/or the second LED driver 412 may be implemented in a logic circuit on an integrated circuit. Related functions of the LED driver 410, the first LED driver 411, and/or the second LED driver 412 may be implemented as hardware using hardware description languages (for example, Verilog HDL or VHDL) or other suitable programming languages. For example, the related functions of the LED driver 410, the first LED driver 411, and/or the second LED driver 412 may be implemented in one or more controllers, microcontrollers, microprocessors, application-specific integrated circuits (ASICs), digital signal processors (DSPs), field programmable gate arrays (FPGAs) and/or various logic blocks, modules and circuits in other processing units.

In terms of software and/or firmware, the related functions of the LED driver 410, the first LED driver 411, and/or the second LED driver 412 may be implemented as programming codes. For example, the LED driver 410, the first LED driver 411, and/or the second LED driver 412 may be implemented using general programming languages (for example, C, C++ or assembly language) or other suitable programming languages. The programming codes may be recorded/stored in a recording medium, and the recording medium includes, for example, a read only memory (ROM), a storage device, and/or a random access memory (RAM). A computer, a central processing unit (CPU), a controller, a microcontroller or a microprocessor may read and execute the programming codes from the recording medium, thereby achieving the related functions. As the recording medium, a non-transitory computer readable medium, such as a tape, a disk, a card, a semiconductor memory, or a programmable logic circuit, may be used. The program may be provided to the computer (or CPU) via any transmission medium (communication network, broadcast wave, etc.). The communication network is, for example, the Internet, wired communication, wireless communication, or other communication media.

In summary, in the driving device and the driving method according to the embodiments, a current-to-voltage converter and an LED driver are used to control a switch. For example, the current-to-voltage converter converts the control current of the driving channel of the first LED driver into the control voltage, and the switch determines whether to enable the light-emitting element in the backlight area of the backlight module according to the control voltage. With the light-emitting element in the backlight area enabled, the driving channel of the second LED driver is capable of controlling a current of the light-emitting element in the backlight area. Therefore, the driving device facilitates the local dimming function.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A driving device configured to drive a backlight module, comprising:
a first LED driver;
a first current-to-voltage converter;
a first switch; and
a second LED driver, wherein
the first LED driver comprises a first driving channel;
the first current-to-voltage converter is coupled to the first driving channel of the first LED driver, and is configured to generate a first control voltage corresponding to a control current of the first driving channel;
the first switch has a control terminal coupled to the first current-to-voltage converter to receive the first control voltage, wherein a first terminal of the first switch is configured to be coupled to a voltage source, and a second terminal of the first switch is configured to be coupled to a first terminal of a first light-emitting element of the backlight module; and
the second LED driver comprises a second driving channel, wherein the second driving channel of the second LED driver is configured to be coupled to a second terminal of the first light-emitting element of the backlight module.

2. The driving device according to claim 1, wherein the first driving channel comprises a controllable current source and a pulse width modulation control circuit, wherein
the controllable current source is coupled to the first current-to-voltage converter to provide the control current; and
the pulse width modulation control circuit is configured to control the control current of the controllable current source.

3. The driving device according to claim 1, wherein the second terminal of the first switch is further configured to be coupled to a first terminal of a second light-emitting element of the backlight module, and the second LED driver comprises a third driving channel, the third driving channel of the second LED driver is configured to be coupled to a second terminal of the second light-emitting element of the backlight module.

4. The driving device according to claim 3, wherein the first light-emitting element is of the same color as the second light-emitting element.

5. The driving device according to claim 1, further comprising a second current-to-voltage converter and a second switch, wherein
the first LED driver comprises a fourth driving channel, the second current-to-voltage converter is coupled to the fourth driving channel of the first LED driver, and is configured to generate a second control voltage corresponding to a current of the fourth driving channel; and
the second switch has a control terminal connected to the second current-to-voltage converter to receive the second control voltage, wherein a first terminal of the second switch is configured to be coupled to the voltage source, a second terminal of the second switch is configured to be coupled to a first terminal of a third light-emitting element of the backlight module, and the second driving channel of the second LED driver is further configured to be coupled to a second terminal of the third light-emitting element of the backlight module.

6. The driving device according to claim 5, wherein the first light-emitting element is of a different color from the third light-emitting element.

7. A driving method for a driving device to drive a backlight module to provide backlight, wherein the backlight module is divided into a plurality of backlight areas, the driving device comprises a first LED driver, a first current-to-voltage converter, a first switch, and a second LED driver, the first current-to-voltage converter is configured to generate a first control voltage corresponding to a control current of a first driving channel of the first LED driver, a control terminal of the first switch receives the first control voltage, a first terminal of the first switch is configured to be coupled to a voltage source, a second terminal of the first switch is configured to be coupled to a first terminal of a first light-emitting element of the backlight module, and a second driving channel of the second LED driver is configured to be coupled to a second terminal of the first light-emitting element of the backlight module, the driving method comprising:
during a period of generating the first control voltage, lighting a first backlight area of the plurality of backlight areas, and receiving, by the second LED driver, driving data for driving a second backlight area of the plurality of backlight areas.

8. The driving method according to claim 7, wherein the backlight module provides backlight to a display panel, each of the plurality of backlight areas is a continuous area, and a long side direction of each of the plurality of backlight areas is parallel to a short side direction of the display panel.

9. The driving method according to claim 7, wherein the backlight module provides backlight to a display panel, each of the plurality of backlight areas comprises a plurality of discrete areas, a display area of the display panel is divided into a plurality of sub-areas, and each of the plurality of sub-areas corresponds to at least one discrete area of each of the plurality of backlight areas.

10. The driving method according to claim 7, wherein the backlight module provides backlight to a display panel and comprises a plurality of light-emitting elements of different colors, the driving method comprising:
during a first period, driving the backlight module to provide a first color light to the display panel; and
during a second period after the first period has ended, driving the backlight module to provide a second color light to the display panel.

11. The driving method according to claim 7, wherein the backlight module provides backlight to a display panel, the plurality of backlight areas are arranged along an arrangement direction parallel to a screen refresh direction of the display panel, the driving method comprising:
during a first period, driving the first backlight area of the plurality of backlight areas by the driving device to provide a first color light to the display panel;
during a second period after the first period has ended, driving the first backlight area by the driving device to provide a second color light to the display panel;
during a third period after the second period has ended, driving the first backlight area by the driving device to provide a third color light to the display panel;
during a fourth period, driving the second backlight area of the plurality of backlight areas by the driving device to provide the first color light to the display panel, wherein a start time of the fourth period is later than a start time of the first period, and the fourth period partially overlaps the first period;
during a fifth period after the fourth period has ended, driving the second backlight area by the driving device to provide the second color light to the display panel, wherein a start time of the fifth period is later than a start time of the second period, and the fifth period partially overlaps the second period; and
during a sixth period after the fifth period has ended, driving the second backlight area by the driving device to provide the third color light to the display panel, wherein a start time of the sixth period is later than a start time of the third period, and the sixth period partially overlaps the third period.

12. The driving method according to claim 11, further comprising:
during a first skip period between the first period and the second period, controlling the first backlight area not to emit light by the driving device;
during a second skip period between the second period and the third period, controlling the first backlight area not to emit light by the driving device;
during a third skip period between the fourth period and the fifth period, controlling the second backlight area not to emit light by the driving device; and
during a fourth skip period between the fifth period and the sixth period, controlling the second backlight area not to emit light by the driving device.
